(19) United States
(12) Patent Application Publication
(10) Pub. No.: US 2025/0326002 A1
(43) Pub. Date: Oct. 23, 2025

(54) METHOD OF MASKING SCUFF OR SCRATCH MARKS ON CONTAINERS

(71) Applicant: Diversey, Inc., Fort Mill, SC (US)

(72) Inventors: Priya SINGH, Mumbai (IN); Sandeep CHAVAN, Belapur (IN); Kedar CHAUDHARI, Thane (IN); Chetan Dnyandev AREKAR, Maharashtra (IN)

(73) Assignee: Diversey, Inc., Fort Mill, SC (US)

(21) Appl. No.: 19/181,547

(22) Filed: Apr. 17, 2025

(30) Foreign Application Priority Data
Apr. 20, 2024 (IN) 202431031534

(51) Int. Cl. B05D 1/28

(52) U.S. Cl. CPC B05D 1/28; B05D 2203/35; B05D 2401/10

(57) ABSTRACT

Provided is a method for masking scuff and/or scratch marks that develop over time on containers. More specifically, the method includes coating the scuff and/or scratch marks on the container with a coating composition that includes renewable and sustainable oils and biodegradable surfactants, and optionally a diluting solvent. The coating composition is disposed on the outer surface of the container, thus masking or covering the scuff and/or scratch marks on the container.

### CROSS REFERENCE TO RELATED APPLICATIONS

This application claims the benefit of Indian Provisional application number 2024/31031534, filed 20 Apr. 2024, the entire contents of which are hereby incorporated by reference.

### TECHNICAL FIELD

Provided is a method for masking scuff and/or scratch marks that develop over time on containers. The method includes coating the scuff and/or scratch marks on the container with a coating composition that includes renewable and sustainable oils and surfactants, and optionally a diluting solvent. The coating composition is disposed on the outer surface of the container, thus masking or covering the scuff and/or scratch marks on the container.

### BACKGROUND

The present invention offers a renewable and sustainable, green approach for masking or coating scuff and/or scratch marks generated on a container, such as a bottle of beer, beverages, juice, and mineral water are repeatedly used for several cycles. When repeatedly used, defects such as, scuff marks and scratches, are developed on the external surface of the containers. These defects are generated on the external surface due to mutual rubbing of the bottles in the filling and distribution process on the conveyor tract as well as during transit and distribution to customers while the containers are in crates.

The defects decrease the aesthetic look of the containers and reduces brand image and decreases the commercial value of the product, due to bottling and distribution techniques. When the container is a bottle, scuff/scratch marks appear as a white ring over the bottle surface. The whiteness of the scuff that is seen depends on the color of the bottle and design of the bottles since the design affects the intensity/depth of scuff mark or scratch. If the scuff mark is deeper, the whiter the scuff mark appears to the naked eye because of the refraction of the light. The degree of scuffing can be measured using a spectrophotometer to determine whiteness index. There can be one to several scuff rings and the width and depth of the scuff varies depending on the design of the bottles and the number of times the container has been recycled. The average width of the scuff marks can vary anywhere from 1 mm to 15 mm.

Widespread practice is to coat the containers or bottles with a coating composition during the recycling process. The coating composition is applied to the containers or bottles and covers the portion where the defect is located. Once applied, the coating composition masks the defects, thus enhancing the appearance of the beverage containers.

After masking or coating the scuff/scratch marks the whiteness value of scuff can be reduced.

Packaging and bottling companies often use glass bottles as a significant part of their packaging material. Due to increasing energy costs and focus on sustainability, returnable glass bottles have become an effective option for this industry. Other packaging materials like plastic bottles, aluminum cans and multilayered layer packaging involving films have raised concern for sustainability and environmental impact for brewing and beverage industry.

The returnable glass bottle is a highly sustainable and efficient way wherein the bottles can be collected post use, cleaned, and reused; that can be defined as returnable glass bottles (RGB). This invention is to increase the life, appearance, and reuse cycles of the returnable glass bottles. The challenge with the returnable glass bottles is that, when repeatedly used, scuff marks are developed on the external surface of the containers/returnable glass bottles. These scuff marks are generated on external surface due to mutual rubbing of bottles. These scuff marks are usually generated during the cleaning, filling, and distribution process on the conveyor track. Furthermore, these scuff marks are also generated during the transit, distribution, and collection from the customers downgrading the aesthetic look or appealing look of the containers and reduces brand image, decrease the commercial value of bottled beverages. Therefore, it is necessary to coat a coating agent onto the portion of scuff marks/scratches, thus masking the scuff marks/scratches inconspicuous and enhancing the appearance. However, the current solutions are not sustainable and renewable.

To solve the scuffing problem the widespread practice was to discard the container or to coat the container with a mineral oil, or a paraffin oil based composition. The coating composition is applied to the container, which covers the portion where the defect (scuff/scratch marks) is located. Once applied, the coating composition masks the defects, thus enhancing the appearance of the beverage containers. The reuse of containers, such as glass bottles, as a sustainable and renewable approach by the industry, is actively sought. Hence, there is a need for a renewable and sustainable coating composition that coats the defects on the beverage containers without causing increased drying times, etc., to prevent a decrease in productivity. Another objective is to provide a coating composition that is able to coat containers whether they are wet with condensation or dry containers. The present composition and methods will address the sustainable and renewable needs of the industry.

The current solutions are not sustainable and renewable. Hence, there is a need for a renewable and sustainable coating composition that coats the defects on the beverage containers without causing increased drying times to prevent a decrease in productivity. The coating composition would also be able to coat containers that have condensation while also being able to coat dry containers providing comparable results.

In ordered to address this industry problem, the following renewable and sustainable coating compositions are proposed that can be applied on the container. This innovative renewable and sustainable coating masks the scuff rings of the container and improves the appearance of the bottle which helps to maintain the aesthetic and appealing look of the bottle.

One practice is to coat the containers or bottles with a coating composition during the recycling process. The coating composition is applied to the outer surface of the containers or bottles and the composition covers the portion where the defect (scuff and scratch marks) is located. Once applied, the coating composition masks the defects, thus enhancing the appearance of the beverage containers. But there is a need for a renewable and sustainable coating composition that coats the defects on the beverage containers without causing increased drying time. The coating composition would be able to coat containers that have condensation while also coating dry containers.

The current method resolves the problem of scratch/scuff marks on bottle by providing a sustainable and renewable approach. This solution not only improves the appearance but also helps in increasing the lifecycle of the bottles with the greener approach.

Renewable and sustainable long-lasting coating of scuff or scratch developed on glass bottles even in wet conditions; address the industry need of sustainability and renewability; provide superior resistance to ice water; used as a post coating, it reduces the friction between the bottles while they travel on the conveyor track; bottles can be used for longer periods of time increasing the life cycle of bottles; provides improved brand image and stimulated sales; provides an improved aesthetic look of bottles in a renewable and sustainable way which helps in generating sales, branding, and reduction of cost for buying new bottles.

The objectives of the current work was to provide raw materials which are biodegradable and from renewable sources and has the ability to provide scuff/scratch masking even on condensed containers. Being able to pass an Ice water resistance test for 24 hr. (coating retention) while maintaining a low L-value (whiteness index) indicating better masking of scuff marks. Finally, the composition should have no tacky look or feel of the container.

Additional objects, advantages, and features of what is claimed will be set forth in the description that follows and in part will become apparent to those skilled in the art upon examination of the following or may be learned by the practice of the technology. The objects and advantages of the presently disclosed and claimed inventive concepts will be realized and attained by means of the compositions and methods particularly pointed out in the appended claims, including the functional equivalents thereof.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a method of masking scuff and/or scratch marks on an outer surface of a container, said method comprising the steps of providing the container having the outer surface wherein the outer surface comprises at least one scuff or scratch. measuring an initial whiteness value or index (L* value %) of the at least one scuff or scratch. Subsequently a coating composition is disposed on and in direct contact with the outer surface of the container, wherein the coating composition comprises an oil present in an amount of from about 10 to about 98 wt % of the coating composition; a surfactant, such as a biodegradable surfactant chosen from alkoxylated alcohols, sorbitans, ethoxylated sorbitans, ethoxylated fatty glycerol esters, alcohol fatty acid esters, soyabean phospholipids, sucrose fatty acid esters, fatty alcohols, fatty alcohol alkoxylates, castor oil ethoxylates, sorbitan ethoxylated esters, sorbitan esters, and combinations thereof, that is present in an amount of from about 2 wt. % to about 60 wt. % of the coating composition; and measuring a secondary whiteness value of the at least one scuff or scratch after the step of disposing the coating composition on the outer surface of the container, wherein the secondary whiteness value is less than the initial whiteness value.

Also provided is the container that is produced by treating the outer surface of a container, such as a glass beverage container, with a composition that includes oils, surfactants, and optionally a diluting solvent.

### BRIEF DESCRIPTION OF THE DRAWINGS

The present disclosure will hereinafter be described in conjunction with the following drawing figures, wherein like numerals denote like elements, and wherein:

FIG. 1, displays the spectrocolorimeter reading (light fastness, L*) for bottles coated with different samples 1-9

FIG. 2, displays the spectrocolorimeter reading (light fastness, L*) for bottles coated with potential prototypes for samples 10-15

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Provided is a method of masking scuff and/or scratch marks on an outer surface of a container. The method includes the steps of providing the container having the outer surface having at least one scuff or scratch. The terms scuff and scratch are used interchangeably throughout the current application. An initial whiteness index or L-value of the at least one scuff or scratch is measured. The whiteness index or L-value can be determined using spectrophotometer techniques. Subsequently, the scuff marks and scratches on the outer surface of the container are treated by disposing a coating composition on and in direct contact with the scuff marks and/or scratches on the surface of the container. The coating composition comprises a renewable and sustainable oil, such as vegetable oil, coconut oil, palm kernel oil, grape seed oil, linseed oil, sunflower oil, soyabean oil, rice bran oil, safflower oil, palm olein oil, grape seed oil, mustard oil, groundnut oil, castor oil, cocoa butter oil, almond oil, avocado oil, Brazil nut oil, cashew oil, cashew nut shell oil, neem oil, linseed oil, double boiled linseed oil, chia seed oil, corn oil, cottonseed oil, flaxseed oil, hemp seed oil, vigna mungo oil, olive oil, palm oil, lesquerella oil, canola oil, peanut oil, pecan oil, perilla oil, sesame oil, walnut oil, meadowfoam oil, biosynthesized oil, dehydrated castor oil, castor oil ethoxylates, hydrogenated castor oil, turkey red oil, sulfonated oils, sulfated oil, linseed polyol, epoxidized soyabean oil, palm oil based macromer, and combinations thereof. The oil is present in the coating composition in an amount of from about 10 to about 98 wt % of the coating composition. The coating composition also includes a surfactant, such as alkoxylated alcohols, sorbitans, ethoxylated sorbitans, ethoxylated fatty glycerol esters, alcohol fatty acid esters, soyabean phospholipids, sucrose fatty acid esters, fatty alcohols, fatty alcohol alkoxylates, castor oil ethoxylates, sorbitan ethoxylated esters, sorbitan esters, and combinations thereof. The surfactant can be present in the coating composition in amounts of from about 2 wt. % to about 60 wt. % of the coating composition. After the coating composition is applied or disposed on the scuff mark(s) and/or scratch(es), a secondary whiteness value of the at least one scuff mark and/or scratch is measured. The whiteness index of L-value can be decreased from about 100% to about 10%, or from about 90% to about 40%.

In some aspects of the method, the oil is chosen from oil is chosen from sunflower oil, soyabean oil, rice bran oil, safflower oil, castor oil turkey red oil, and combinations thereof.

In some aspects of the method, the oil is present in an amount of from about 10 wt. % to about 98 wt. % of the coating composition, or from about 40 wt % to about 95 wt. % of the coating composition.

In other aspects of the method, the surfactant is a biodegradable surfactant, which includes alkoxylated alcohols, sorbitans, ethoxylated sorbitans, ethoxylated fatty glycerol esters, alcohol fatty acid esters, soyabean phospholipids, sucrose fatty acid esters, fatty alcohols, fatty alcohol alkoxylates, castor oil ethoxylates, sorbitan ethoxylated esters, sorbitan esters, and combinations thereof.

In other aspects of the method, the biodegradable surfactant can be an alkoxylated alcohol having from about 2 to about 25 moles of ethylene oxide, propylene oxide, or a combination thereof.

In some aspects of the method, the surfactant is present in an amount of from about 2 wt. % to about 60 wt. % of the coating composition, or from about 5 wt. % to about 40 wt. % of the coating composition.

In other aspects of the method, the ratio of the oil to surfactant can be from about 4:6 to about 9.8:0.2, or from about 7:3 to about 9.5:0.5.

In other aspects of the method, the coating composition further contains a solvent that can be water, polyethylene glycol, alcohol, ether, glycol ether, polyether, and combinations thereof.

In some aspects of the method, the oils and the surfactants are combined and then emulsified with the solvent.

In yet other aspects of the method, a solvent is present in an amount of from greater than 0 wt. % up to about 95 wt. % based on a total weight of the coating composition.

In other aspects of the method, the weight ratio of solvent to coating composition is from about 95:2 to 2:96.04, or from about 95:0.1 to about 2:58.8, or 10:0.25 to 5:3, or 9:1.

In other aspects of the method, the coating composition has a hydrophile lipophile balance (HLB) of from about 2 to about 20, or from about 6 or from about 18.

In other aspects of the method, the coating composition comprises from about 10 wt. % to about 98 wt. % oil, from about 2 wt. % to about 60 wt. % surfactant, and from 0 wt. % to about 95 wt. % solvent.

In some aspects of the method, the container comprises glass, plastic, polyethylene terephthalate (PET), polyethylene naphthalate (PEN) or polycarbonate (PC).

In other aspects of the method, the container is a glass bottle.

In other aspects of the method, the step of disposing the coating composition onto the container is accomplished using an applicator chosen from an absorbent pad, a brush, a contact belt, a cotton cloth, filter paper, a roller, a spray device, a sponge, an expulsion pad, tissue paper, a dip/bath, and combinations thereof.

In other aspects of the method, the whiteness value of the scuff marks and/or scratches on the container decreased by at least 40%, or by at least 10% when compared with a container having no coating.

Also provided is a container that is produced by treating the outer surface of a container, such as a glass beverage container, with a composition that includes oils, surfactants, and optionally a diluting solvent.

In some aspects of the method, the container is glass, a box, a crate, a can, or a barrel.

In some aspects of the method, the container can be further rinsed and/or dried. For example, the container can be rinsed with water and dried via air drying, heat drying, or just allowing the container to dry naturally.

Finally, the coated container produced by the above described methods is provided. The container having the coating composition described above will have efficacy in providing durability and aesthetic look to the container of at least 8 hours in an ice water resistance test, which is described below.

### EXAMPLES

The following examples are intended as illustrations only. Unless otherwise noted, all parts, percentages, and ratios reported in the following examples are on a weight basis, and all reagents used in the examples were obtained, or are available, from the chemical suppliers described below, or may be synthesized by conventional techniques.

### Example 1

Coating compositions were prepared by combining the oils, surfactants, and diluting solvent as shown in Table 1 and Table 2 below. In the following studies, scuffed bottles were collected and the whiteness of the scuff marks or rings on the bottle were measured using an X-Rite spectrophotometer. 100 grams of a 10% solution of the compositions shown in Table 1 (10grams at roughly a 9:1 oil: surfactant ratio and 90 grams water for a total 100 grams), were mixed in water and stirred for 2 minutes. A spray bottle was filled with the solution and the solution was sprayed onto the scuffed rings on the bottles. The composition was allowed to dry, and the spray process repeated until the scuff marks were covered with the composition, this generally took 4-5 sprays to cover the entire scuffed ring. The bottles were dried at room temperature for 1 hour and the whiteness of the scuff marks measured again using X Rite spectrophotometer. Whiteness values of lower than 22 were the objective.

### Ice Water Resistance Test

The coated bottles were evaluated both through visual observation after the coating is applied and dried and also the ability of coating composition to withstand an ice test as described below.

The general procedure as outlined here was used for the ice water resistance test in the following examples. Three transparent bottles having scuff marks were filled with a methylene blue and water solution, which highlighted the scuffed area on the bottle. The room lights were dimmed and 6 readings of the whiteness index of the scuff marks were measured using an X-Rite Spectrocolorimeter. The bottles were emptied, and the methylene blue/water solution replaced with ice water to create condensation on the surface of the bottles. A 10% Maskant solution was then sprayed on the scuff marks on the bottle until covered with the Maskant solution. The bottles were dried for 1 hour at room temperature and then the whiteness index of the scuff marks were remeasured. A whiteness index of lower than 22 was the intended goal.

For the ice test, an ice bath was first prepared in which a 1-2 inch layer of ice was placed in the ice bath. The coated bottles are then placed either horizontal or vertical on the ice. The remaining space in the ice bath was also filled with ice, so that the glass bottles were surrounded by the ice. The bottles are maintained in the ice bath for 24 hours and the bottles were taken out of the ice bath and dried at room temperature for 1 hour and the whiteness of the scuff marks measure again. Masking performance was considered good if the whiteness of the scuff marks were lower than 22. Pictures were taken before the coating composition was applied, after coating the bottles with the composition, and after the ice water resistance test to visually compare performances.

Glass bottles were filled with liquid. Two different tests were performed, test 1 with room temperature liquid filled bottles and test 2 with chilled liquid (2° C. to 8° C.) filled bottles where condensation was present on the bottle surface. The emulsified solution was applied to 2 bottles on the entire external surface of the bottles for both tests. A spectrocolorimeter was used to measure the scuffs (white rings on the external bottle surface) before and after the application of the emulsified solution. The scuffs were measured based on the whiteness of the scuffs and a whiteness value (L* value) was given. The higher the L* value, the greater the depth of the scuff. A decrease in L* value indicates that scuff was coated by the emulsified solution after coating the bottle.

TABLE 1
Example 1, Coating Formulations and Ice Water Resistance Test Results

| Raw | Sample | Sample | Sample | Sample | Sample | Sample | Sample | Sample | Sample |
|---|---|---|---|---|---|---|---|---|---|
| Material details | 1 | 2 | 3 | 4 | 5 | 6 | 7 | 8 | 9 |
| Tall Oil | 10 | 5 | — | 5 | 5 | 5 | 5 | 5 | — |
| Fatty Acid | | | | | | | | | |
| Alcohol | 5 | 5 | 5 | 5 | 5 | 5 | 5 | 5 | 5 |
| (C2-14) | | | | | | | | | |
| Ethoxylate | | | | | | | | | |
| (3EO) | | | | | | | | | |
| (Brij L3) | | | | | | | | | |
| Sunflower | 85 | 90 | | | | | | | |
| oil | | | | | | | | | |
| Rice bran | | | | | | | 90 | | |
| oil | | | | | | | | | |
| Soyabean | | | | | | 90 | | | |
| oil | | | | | | | | | |
| Safflower | | | | | 90 | | | | |
| oil | | | | | | | | | |
| Castor oil | | | 95 | 90 | | | | | |
| Türkiye | | | | | | | | 90 | 95 |
| red oil | | | | | | | | | |
| Whiteness | 39.3 | 35.6 | 45.3 | 49.2 | 49.5 | 48.7 | 42.1 | 45 | 44.3 |
| value | | | | | | | | | |
| before | | | | | | | | | |
| application | | | | | | | | | |
| Whiteness | 20.2 | 21 | 20.3 | 21.5 | 24.8 | 17.9 | 18.8 | 24.3 | 17.7 |
| value after | | | | | | | | | |
| application | | | | | | | | | |
| Drying | 30 | 32 | 45 | 35 | 33 | 30 | 30 | 36 | 60 |
| time | | | | | | | | | |
| (min.) | | | | | | | | | |
| Ice Water | 20.9 | 22.2 | 21.6 | 21.3 | 26.2 | 21.8 | 21.1 | 33.2 | 35.9 |
| Resistance | | | | | | | | | |
| test | | | | | | | | | |

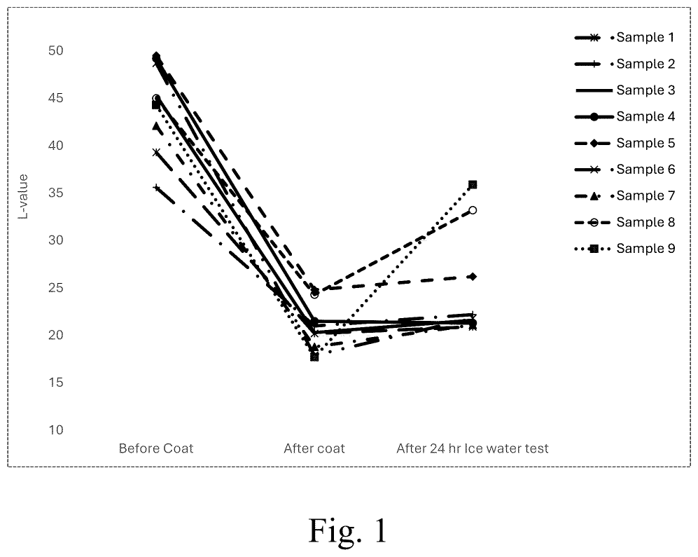

Visually no whiteness observed on the bottles after coating, after 24 hours of ice test. The Spectro colorimetric readings also show the lowest whiteness value as shown in FIG. 1. The renewable and sustainable solution provides good coating to the bottle, improves the aesthetic look of the bottle, coating dries faster in 5 minutes, gives a shiny look to the bottle, neither mass transfer nor tacky look to the bottle, passes 24 hours with renewable and sustainable approach. As all raw materials used in the examples are referred as biodegradable and from renewable resource, it will also be seen that surfactants that are not biodegradable can be used (see Example 3 and Example 4).

From Table 1, it can be seen that samples no. 1-9, give excellent coating of scuff/scratch marks on the bottles when applied. Complete drying times take about 30 to 60 minutes. Except for samples no. 5, 8 & 9, the rest all passed the 24 hour ice water test with L-value less than or equal to 22.

### Example 2

The compositions used in this example were prepared in the same fashion as in Example 1 and subjected to both the visual and ice resistance test. The formulations used in this study are described below in Table 2.

TABLE 2
Example 2, Coating Formulations and Ice Water Resistance Test Results

| Raw | Sample | Sample | Sample | Sample | Sample | Sample |
|---|---|---|---|---|---|---|
| Material details | 10 | 11 | 12 | 13 | 14 | 15 |
| Alcohol | 5 | 10 | 10 | 5 | 5 | 10 |
| (C₂₋₁₄) | | | | | | |
| Ethoxylate | | | | | | |
| (3EO) (Brij | | | | | | |
| L3) | | | | | | |
| Sunflower | | 80 | 80 | 85 | | |
| oil | | | | | | |
| Rice bran | | | | | 85 | |
| oil | | | | | | |
| Castor oil | | | 10 | | | |
| Dehydrated | 95 | 10 | | 10 | 10 | 90 |
| Castor Oil | | | | | | |
| Whiteness | 40.6 | 41.6 | 38.2 | 45 | 36.8 | 33.4 |
| value | | | | | | |
| before | | | | | | |
| application | | | | | | |
| Whiteness | 17.2 | 17.8 | 18.4 | 18.8 | 18 | 11.5 |
| value after | | | | | | |
| application | | | | | | |
| Drying | 28 | 21 | 35 | 21 | 24 | 25 |
| Time | | | | | | |
| (minutes) | | | | | | |
| Ice Water | 20.8 | 20.5 | 21.1 | 18.8 | 20.4 | 20.2 |
| Resistance | | | | | | |
| Test | | | | | | |

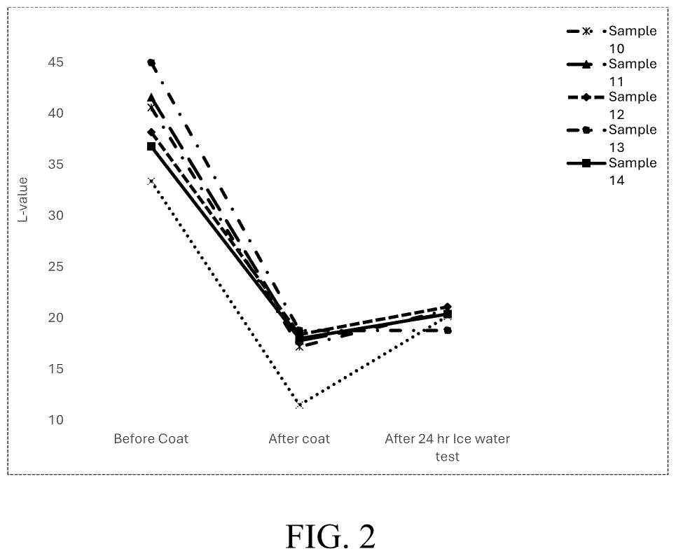

As can be seen from the results of Table 2, Sample no. 10-15, offers good scuff masking along with an excellent ice water retention test for 24 hr. as shown in FIG. 2. Here vegetable oils along with derived vegetable oil offer lower overall drying time, lower whiteness value indicating better scuff/scratch coating even after a 24 hrs. ice test.

### Supplemental Data

The compositions used in Examples 3 and 4, were prepared in the same fashion as in Examples 1 and 2, and subjected to both the visual and ice resistance test. The formulations used in Examples 3 and 4 are described below in Tables 3 and 4, respectively.

### Example 3

TABLE 3
Example 3, Coating Formulations and Ice Water Resistance Test Results

| Raw Material | Smpl. | Smpl. | Smpl. | Smpl. | Smpl. | Smpl. | Smpl. | Smpl. | Smpl. | Smpl. | Smpl. |
|---|---|---|---|---|---|---|---|---|---|---|---|
| details | 16 | 17 | 18 | 19 | 20 | 21 | 22 | 23 | 24 | 25 | 26 |
| Tall Oil Fatty Acid | 20 | 20 | 20 | | | 20 | | 10 | | 10 | |
| Sorbitan mono | 3.5 | 3.5 | 3.5 | 3.5 | 3.5 | 3.5 | | 3.5 | | | 5 |
| oleate 20EO | | | | | | | | | | | |
| Alcohol (C2- | 6.5 | 6.5 | 6.5 | 6.5 | 6.5 | 6.5 | 13.5 | 6.5 | 5 | 10 | |
| 14) Ethoxylate | | | | | | | | | | | |
| (3EO) | | | | | | | | | | | |
| (Eco Brij L3) | | | | | | | | | | | |
| Sunflower oil | 70 | | | 70 | 80 | | 86.5 | 80 | 95 | 80 | 95 |
| Palm oil | | 70 | | | | | | | | | |
| Soyabean oil | | | 70 | | | | | | | | |
| Linseed oil | | | | 20 | | | | | | | |
| Ricebran oil | | | | | | 70 | | | | | |
| Whiteness | 40.9 | 40 | 36.7 | 40.1 | 40.1 | 36.2 | 42.8 | 43.5 | 43.9 | 42.3 | 30.6 |
| value before | | | | | | | | | | | |
| application | | | | | | | | | | | |
| Whiteness | 20.4 | 22.7 | 20.8 | 20.4 | 21.6 | 20.6 | 19.2 | 17.5 | 19.3 | 20.1 | 17.8 |
| value after | | | | | | | | | | | |
| application | | | | | | | | | | | |
| Drying time (min.) | 24 | 22 | 22 | 24 | 20 | 24 | 31 | 34 | 36 | 42 | 45 |
| ICWRT value | 22.6 | 21.4 | 21.3 | 21.3 | 22.6 | 23.5 | 28.3 | 26.8 | 20.5 | 21 | 20.3 |

It can be seen that samples no. 16-26, give excellent coating of scuff/scratch marks on the bottles when applied. Complete drying times take about 22 to 45 minutes. Except for samples no. 16, 20-23, the rest passed the 24 hour ice water test with L-value less than or equal to 22.

### Example 4

TABLE 4
Example 4, Coating Formulations and Ice Water Resistance Test Results

| Raw Material | Sample | Sample | Sample | Sample | Sample | Sample |
|---|---|---|---|---|---|---|
| details | 27 | 28 | 29 | 30 | 31 | 32 |
| Sunflower oil | 70 | 90 | 80 | | | |
| Soy Oil | | | | 80 | | |
| Palm Oil | | | | | 85 | |
| Canola oil | | | | | | 85 |
| Dehydrated | | 5 | | | | |
| Castor oil | | | | | | |
| Sorbitan | 15 | | | | | |
| monolaurate | | | | | | |
| Polysorbate 80 | 15 | 2 | | | | |
| Sorbitan | | 3 | | | | |
| monooleate | | | | | | |
| C13C15-Oxo | | | 20 | 20 | 15 | 15 |
| alcohol 3 EO | | | | | | |
| (Lutensol AO3) | | | | | | |
| Whiteness value | 38.2 | 33.4 | 37.8 | 41.5 | 35.9 | 40.3 |
| before application | | | | | | |
| Whiteness value | 20.2 | 19.3 | 21.1 | 21.5 | 19.3 | 21.9 |
| after application | | | | | | |
| Ice Water | 21.3 | 21.0 | 22.0 | 21.9 | 21.6 | 22.7 |
| Resistance test | | | | | | |

It can be seen that samples no. 27-32, give excellent coating of scuff/scratch marks on the bottles when applied. Samples no. 27-31, passed the 24 hour ice water test with L-value less than or equal to 22.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

We claim:

1. A method of masking scuff and/or scratch marks on an outer surface of a container, said method comprising the steps of:
providing the container having the outer surface wherein the outer surface comprises at least one scuff or scratch;
measuring an initial whiteness value (L* value %) of the at least one scuff or scratch mark;
subsequently disposing a coating composition on and in direct contact with the outer surface of the container, wherein the coating composition comprises: an oil present in an amount of from about 10 to about 98 wt % of the coating composition; and a biodegradable surfactant chosen from alkoxylated alcohols, sorbitans, ethoxylated sorbitans, ethoxylated fatty glycerol esters, alcohol fatty acid esters, soyabean phospholipids, sucrose fatty acid esters, fatty alcohols, fatty alcohol alkoxylates, castor oil ethoxylates, sorbitan ethoxylated esters, sorbitan esters, and combinations thereof, that is present in an amount of from about 2 wt. % to about 60 wt. % of the coating composition; and
measuring a secondary whiteness value of the at least one scuff or scratch after the step of disposing the coating composition on the outer surface of the container, wherein the secondary whiteness value is less than the initial whiteness value by at least 10%.

2. The method according to claim 1, wherein the oil is chosen from vegetable oil, coconut oil, palm kernel oil, grape seed oil, linseed oil, sunflower oil, soyabean oil, rice bran oil, safflower oil, palm olein oil, grape seed oil, mustard oil, groundnut oil, castor oil, cocoa butter oil, almond oil, avocado oil, Brazil nut oil, cashew oil, cashew nut shell oil, neem oil, linseed oil, double boiled linseed oil, chia seed oil, corn oil, cottonseed oil, flaxseed oil, hemp seed oil, vigna mungo oil, olive oil, palm oil, lesquerella oil, canola oil, peanut oil, pecan oil, perilla oil, sesame oil, walnut oil, meadowfoam oil, biosynthesized oil, dehydrated castor oil, castor oil ethoxylates, hydrogenated castor oil, turkey red oil, sulfonated oils, sulfated oil, linseed polyol, epoxidized soyabean oil, palm oil based macromer, and combinations thereof.

3. The method according to claim 1, wherein the oil is chosen from oil is chosen from sunflower oil, soyabean oil, rice bran oil, safflower oil, castor oil turkey red oil, and combinations thereof.

4. The method according to claim 1, wherein the oil is present in an amount of from about 10 wt. % to about 98 wt. % of the coating composition.

5. The method according to claim 1, wherein the biodegradable surfactant chosen from alkoxylated alcohols, sorbitans, ethoxylated sorbitans, ethoxylated fatty glycerol esters, alcohol fatty acid esters, soyabean phospholipids, sucrose fatty acid esters, fatty alcohols, fatty alcohol alkoxylates, castor oil ethoxylates, sorbitan ethoxylated esters, sorbitan esters, and combinations thereof.

6. The method according to claim 1, wherein the biodegradable surfactant is an alkoxylated alcohol having from about 2 to about 25 moles of ethylene oxide, propylene oxide, or a combination thereof.

7. The method according to claim 1, wherein the biodegradable surfactant is present in an amount of from about 2 wt. % to about 60 wt. % of the coating composition.

8. The method according to claim 1, wherein the ratio of the oil to surfactant is from about 4:6 to about 9.5:0.5.

9. The method according to claim 1, further comprising a solvent chosen from water, polyethylene glycol, alcohol, ether, glycol ether, polyether, and combinations thereof.

10. The method according to claim 9, wherein the oils and the biodegradable surfactants are combined and then emulsified with the solvent.

11. The method according to claim 9, wherein the solvent is present in an amount of from greater than 0 wt. % up to about 95 wt. % based on a total weight of the coating composition.

12. The method according to claim 9, wherein the weight ratio of solvent to coating composition is from about 95:2 to 2:96.04, or from about 95:0.1 to about 2:58.8, or 10:0.25 to 5:3, or 9:1.

13. The method according to claim 1, wherein the coating composition has a hydrophile lipophile balance (HLB) of from about 2 to about 20, or of from about 6-18.

14. The method according to claim 1, wherein the coating composition comprises from about 10 wt. % to about 98 wt. % oil, 0 wt. % to about 98 wt. % oil derivative, from about 2 wt. % to about 60 wt. % surfactant, and from 0 wt. % to about 95 wt. % solvent.

15. The method according to claim 1, wherein the container comprises glass, plastic, polyethylene terephthalate (PET), polyethylene naphthalate (PEN) or polycarbonate (PC).

16. The method according to claim 15, wherein the container is a glass bottle.

17. The method according to claim 1, wherein the step of disposing the coating composition onto the container is accomplished using an applicator chosen from an absorbent pad, a brush, a contact belt, a cotton cloth, filter paper, a roller, a spray device, a sponge, an expulsion pad, tissue paper, a dip/bath, and combinations thereof.

18. The method according to claim 1, wherein the whiteness index of the scuff marks and/or scratches on the container is decreased by at least 20% when compared with a container having no coating.

19. A container produced by the method according to claim 1.

20. The container according to claim 19, wherein the container is a beverage container.
